(19) United States
(12) Patent Application Publication
(10) Pub. No.: US 2009/0076690 A1
(43) Pub. Date: Mar. 19, 2009

(54) Engine Hydraulic Parallel Series Rear Wheel Drive Hybrid Vehicle

(76) Inventors: Heng Guo, Beijing (CN); Xiaolin Zhu, Beijing (CN); Jukul Han, Beijing (CN)

Correspondence Address: KENYON & KENYON LLP, ONE BROADWAY, NEW YORK, NY, 10004, US

(21) Appl. No.: 12/087,498

(22) PCT Filed: Nov. 13, 2006
(86) PCT No.: PCT/CN2006/003032

§ 371 Date: Jul. 8, 2008

(30) Foreign Application Priority Data
Jan. 11, 2006 (CN) 200610000650.1

(51) Int. Cl. B60W 10/24; B60W 20/00

(52) U.S. Cl. 701/51; 180/165

(57) ABSTRACT

The present invention relates to an engine hydraulic parallel series rear wheel drive hybrid vehicle, including a power transmission system for conventional vehicle, an electric control unit and a hydraulic auxiliary power transmission system, that is, braking energy regeneration auxiliary system and idling energy control system. A brake pedal and an accelerator pedal are connected with the hydraulic auxiliary power transmission system through the electronic control unit. The electronic control unit functions to realize harmonious control between the power transmission system and the hydraulic auxiliary transmission system. The electronic control unit receives electric signals given by the brake pedal, the accelerator pedal, the engine and the gear-box. After control strategic operation, the electronic control unit outputs an instruction signal of the auxiliary hydraulic power transmission system. The present invention can realize the recovering and releasing of hydraulic braking energy, utilizing of idling energy, and idling and shutting down of engine. The present invention has the advantages of higher efficiency of kinetic energy conversion, smaller noise, longer lifetime of engine, gas-saving, simpler structure and lower cost. The present invention is applicable to the reconfiguration of existing vehicle.

### FIELD OF THE INVENTION

The present invention relates to an engine hydraulic parallel series rear wheel drive (RWD) hybrid vehicle, and more particularly, to a clean energy saving parallel series rear wheel drive hybrid vehicle equipped with an engine and a hydraulic accumulator, and more particularly, to a parallel series rear wheel drive hybrid vehicle having an engine as main power source and having stored and released hydraulic energy as an auxiliary power source.

### BACKGROUND OF THE INVENTION

As the number of vehicles in China is increasing rapidly, a vehicle with high efficiency, excellent performance and simple structure will become popular. Because vehicles consume kinetic energy when braked and idled, and the kinetic energy can be converted into hydraulic energy by a hydraulic device and then stored in a hydraulic accumulator, in order to be provided to the vehicle as an auxiliary power source when the vehicle starts or accelerates, so as to realize the purpose of recycling and reusing energy. The existing manner of recycling and releasing brake energy is generally to use a storage battery or hydraulic accumulator as buffer medium, and add an auxiliary gear-box, so that a straight gear of the auxiliary gear-box engages with a straight gear of a transmission shaft, thereby transferring the auxiliary power source. This manner of converting and utilizing energy not only results in complex structure, difficult installation, big occupation space of bodywork and increased weight of whole vehicle, but also produces louder noise. However, no relevant materials regarding the application of recycling and reusing the idling energy is available throughout the world. To overcome the above deficiencies, a prior application of the present applicant, Chinese application NO. 200420059673.6, entitled “a diesel-hydraulic parallel rear wheel drive hybrid vehicle”, discloses a technical solution of a diesel-hydraulic parallel rear wheel drive hybrid vehicle, in which a parallel connection of auxiliary power source and rear wheel drive bridge is arranged on the original bodywork, so that an engine parallel rear wheel drive hybrid vehicle of dual power mix driving is obtained, thereby the problem of recycling, recovering and releasing the brake energy is resolved. However, the patent application does not implement power peak modulation on the engine, not apply the recycling method of idling energy to the whole vehicle, and not use computer auxiliary device to control the valve switching solutions in the energy recycling system.

### SUMMARY OF THE INVENTION

The technical problem to be solved by the present invention is to provide an engine hydraulic parallel series rear wheel drive hybrid vehicle. The vehicle uses the engine as the main power source, the braking kinetic energy as the primary auxiliary power source, the idling remaining kinetic energy as the secondary auxiliary power source. Dual power hybrid driving is achieved by a parallel connection of the main power source, the primary auxiliary source and the dual power driving rear axle, and a series connection of the main power source, the secondary auxiliary source and the dual power driving rear axle. The present invention has the advantages of simpler structure, lower cost, higher energy converting efficiency and smaller noise. Power peak modulation can be performed partly on the engine. Accumulation of braking energy, accumulation of idling energy, and control of the released energy can be performed to the vehicle by an industrial controller.

The technical solution of present invention is: an engine hydraulic parallel series rear wheel drive hybrid vehicle including a brake pedal, an accelerator pedal, a rear wheel, and a power transmission system comprising an engine, a gear-box and a dual power driving rear axle, wherein the engine is connected to the gear-box, the gear-box is connected to the dual power driving rear axle through a universal coupling, left and right wheels of the rear wheel are connected with left and right half shafts of the dual power driving rear axle, respectively, the vehicle further including: an electronic control unit, and a hydraulic auxiliary power transmission system, wherein the hydraulic auxiliary power transmission system includes a first subsystem and a second subsystem, wherein the first subsystem is a brake energy regeneration auxiliary system and the second subsystem is a idling energy control system, wherein the brake pedal and the accelerator pedal are connected with the first subsystem and the second subsystem through the electronic control unit. After receiving electric signals given by the brake pedal and the accelerator pedal, the engine, and the gear-box, the electronic control unit outputs an instruction signal for operation of the auxiliary hydraulic power transmission system.

The first subsystem includes a first hydraulic pump/motor, a first hydraulic integrated block, a first clutch, a gasoline strainer, a high pressure accumulator, a low pressure accumulator and an auxiliary tank, wherein a power output shaft of the first hydraulic pump/motor is connected with the dual power rear bridge through the first clutch, an oil drain port of the first hydraulic pump/motor is connected to the auxiliary tank, the first hydraulic pump/motor is connected to the first hydraulic integrated block, the gasoline strainer is connected at outside of the first hydraulic integrated block, and the first hydraulic integrated block has an outlet leading to the high pressure accumulator and the low pressure accumulator.

The first hydraulic pump/motor is a variable piston pump/motor, for which an electric input signal of the variable mechanism is provided by the electronic control unit.

The first hydraulic integrated block includes a first high pressure accumulator pressure maintaining check valve, a high pressure sensor connected with the high pressure accumulator, a low pressure sensor connected with the low pressure accumulator, an oil feed passage check valve, a control motor two position four way switching valve , a first control high pressure accumulator two position four way switching valve, a control low pressure accumulator two position four way switching valve, an internal oil protection check valve, a high pressure accumulator safety overflow valve and a low pressure accumulator safety overflow valve connected with the auxiliary tank, respectively; wherein each of two position four way switching valves has a cartridge valve, an oil feed passage check valve, a cartridge valve of the control low pressure accumulator two position four way switching valve and the low pressure accumulator are sequentially connected between a port B of the first hydraulic pump/motor and a low pressure accumulator safety overflow valve, the gasoline strainer is connected via a cartridge valve of the control motor two position four way switching valve between a port A of the first hydraulic pump/motor and the first high pressure accumulator pressure maintaining check valve, the low pressure accumulator is connected with the gasoline strainer, the high pressure accumulator safety overflow valve and a cartridge valve of the first control high pressure accumulator two position four way switching valve are connected between the first high pressure accumulator pressure maintaining check valve and the high pressure accumulator, the control terminals of the two position four way switching valves, and the control terminal of the first hydraulic pump/motor are connected with an I/O output terminal of the electronic control unit, the high pressure sensor and the low pressure sensor are connected with an A/D input terminal of the electronic control unit.

The second subsystem includes a second hydraulic pump/motor, a second hydraulic integrated block, a second clutch, a power take-off apparatus, and a high pressure accumulator, a low pressure accumulator and an auxiliary tank commonly used by the first subsystem; wherein the second hydraulic pump/motor is connected with the power take-off apparatus; wherein the power take-off apparatus is connected with the gear-box or the engine, the oil drain port of the second hydraulic pump/motor is connected to the auxiliary tank, the second hydraulic pump/motor is connected with the second hydraulic integrated block, the second hydraulic integrated block has oil ports leading to the high pressure accumulator and the low pressure accumulator respectively.

The second hydraulic pump/motor is a variable piston pump/motor, for which an electric input signal of the variable mechanism is provided by the electronic control unit.

The power take-off apparatus is a power take-off, a power take-off gear and a power take-off mechanical interface engaged with a gear on a power output shaft of the power take-off are mounted at the end of a power input shaft of the gear-box, wherein the power take-off is mounted on the gear-box through the interface.

The power take-off apparatus is a power take-off, the power take-off is mounted at the end of a power output shaft of the engine, the gear-box is connected to the other end of the power take-off, a power take-off gear engaged with a gear on a power output shaft of the power take-off is mounted at the end of a power input shaft of the gear-box.

The power take-off apparatus is an engine power output mechanism, which includes an engine crank output shaft, a strap wheel, a driving strap and a bracket, a strap wheel is mounted at an end of an engine crank output shaft which is connected with another strap wheel mounted at an end of the bracket through a strap, the other end of the bracket is connected with the hydraulic pump, the second clutch is mounted in the middle of the bracket.

The second hydraulic integrated block includes a second high pressure accumulator pressure maintaining check valve, an oil feed passage check valve, and a control motor oil conduit distribution two position four way switching valve and a second control high pressure accumulator two position four way switching valve that are respectively connected with the auxiliary tank, wherein, Each of two position four way switching valves has a cartridge valve, a port B of the second hydraulic pump/motor is connected to the low pressure accumulator through the oil feed passage check valve, a port A of the second hydraulic pump/motor is connected to the high pressure accumulator through the second high pressure accumulator pressure maintaining check valve, a cartridge valve of the control motor oil conduit distribution two position four way switching valve is connected between the high pressure accumulator and the oil feed passage check valve, the second high pressure accumulator pressure maintaining check valve is connected between the cartridge valve and a cartridge valve of the second control high pressure accumulator two position four way switching valve, the cartridge valve is connected with a port A of the second hydraulic pump/motor and the low pressure accumulator, control terminals of the two position four way switching valves and are connected with an I/O output terminal of the electronic control unit .

When the first hydraulic pump/motor or the second hydraulic pump/motor is used in the state of a hydraulic pump, the port A is a high pressure oil-pushing port, the port B is a low pressure oil-sucking port; when the first hydraulic pump/motor or the second hydraulic pump/motor is used in the state of a motor, the port A is a low pressure oil-return port, the port B is a high pressure oil-entry port.

The numbers of the high pressure accumulator and the low pressure accumulator are respectively at least one.

The dual power driving rear axle is a dual power driving rear axle for a parallel hybrid vehicle.

To make the vehicle not flameout when the vehicle is idling, the engine's idling power must have certain storage. At this time, storage power is often higher than the actual power of idling. The difference of actual power value higher than that of idling is considered as power difference. Any vehicle has certain power difference when idling. A hydraulic pump in the power range is selected according to the power difference; meanwhile the idling storage torque of the engine should be also larger than maximum actual driving torque of the selected hydraulic pump. Based on this principle, if remaining power generated when the engine is idling is used to drive the power take-off apparatus, such as power output mechanism, mounted in present application, the power difference of remaining energy could be recycled so that the ability of utilizing energy is improved.

### BENEFICIAL EFFECTS OF PRESENT INVENTION ARE

1. Simpler structure and lower cost: since the present invention not only adds some components such as hydraulic pumps/motors, hydraulic tanks, hydraulic accumulators and control circuit on the chassis of original vehicle, but also adds a parallel connection of a first electromagnetic clutch between the main power source and primary auxiliary power source through “dual power driving rear axle”, mounts a power take-off apparatus on the engine or the gear-box, and adds a series connection of a second electromagnetic clutch between the hydraulic pumps. The present invention has simpler structure and does not require special design. The present invention is applicable to the reconfiguration of existing vehicle. When the vehicle is running in constant speed on the speedway, the speed of the vehicle can be same as that before reconfiguration by disconnecting electromagnetic clutch. When the vehicle needs to increase power, the power of the vehicle can be increased to the energy level of the sum of original output power of engine and output power of hydraulic accumulator by the driving of dual power. When the electromagnetic clutch is pulled in, the hybrid vehicle has the functions of recycling of braking energy, utilizing of idling remaining energy, power peak modulating of engine and releasing of energy. Therefore, the present invention not only can satisfy the need that the vehicle is running on speedway in modem city, but also can be applicable for vehicle to run in a lower speed in the local streets, stop frequently, and reuse the remaining energy when idling. The present invention is applicable to industrial production, because the components used in present invention are all common universal components.

2. Higher converting efficiency of kinetic energy and smaller noise: by using energy recycling apparatus, the present invention can significantly decrease the usage of braking hubs and reduce the smoke when the vehicle is starting and accelerating, whereby the need of low exhaust is satisfied. Since the present invention employs “dual power driving rear axle” structure instead of increasing the number of auxiliary power gear-box, the noise is reduced greatly.

3. Longer lifetime of engine and better effect of gas-saving: when the vehicle is idling, flameout of engine can often occur due to back-flowing resulting from improper control of engine rotated speed. The lifetime of engine can be shortened due to frequent starting of engine, and the gas consumption becomes larger each time the engine is starting. Because the present invention can recycle the redundant energy generated from the idling of vehicle, back-flowing is prevented. The gas is saved, meanwhile the number of starting the engine is reduced so that the gas is further saved, and the lifetime of engine becomes longer.

4. Control of peak modulation energy of engine and better effect of gas-saving: because an engine power output mechanism is mounted on the vehicle, peak modulation can be partly performed to engine power. The remaining energy is stored in the accumulator when the power provided by the engine is larger than that needed by the vehicle; the energy in the accumulator is released into hydraulic pump when the power provided by the engine is smaller than that needed by the vehicle, so that the effect of gas-saving of the vehicle is improved.

### BRIEF DESCRIPTION OF THE DRAWINGS

FIG. 1 is a structural schematic view according to a first exemplary embodiment of the present invention.

FIG. 2 is a structural schematic view according to a second exemplary embodiment of the present invention.

FIG. 3 is a structural schematic view according to a third exemplary embodiment of the present invention

FIG. 4 is a control logic diagram of a first hydraulic integrated block according to the present invention.

FIG. 5 is a control logic diagram of a second hydraulic integrated block according to the present invention.

FIG. 6 is structural view of an electronic control unit according to the present invention.

### DETAILED DESCRIPTION OF THE PREFERRED EMBODIMENTS

Reference will now be made in detail to the preferred embodiments of the present invention, examples of which are illustrated in the accompanying drawings.

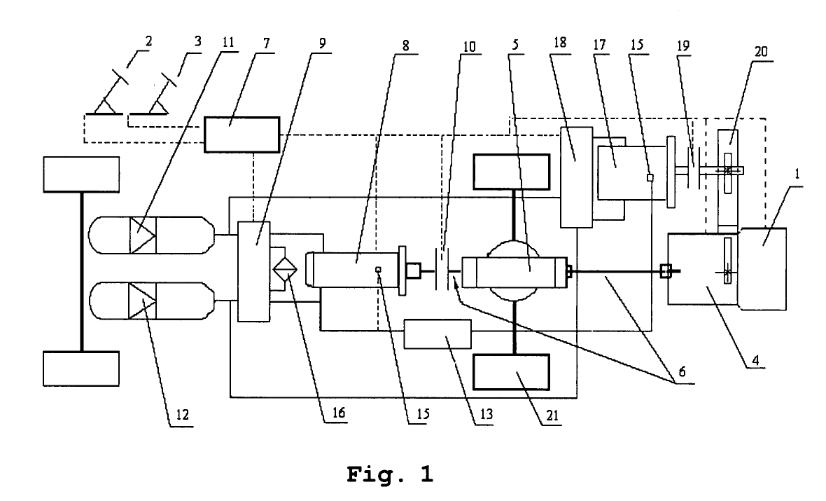

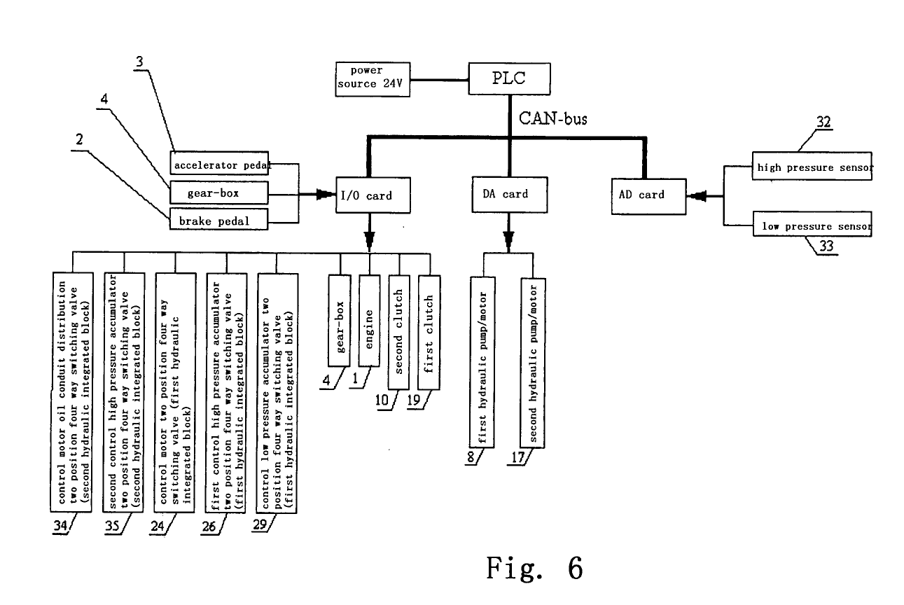

Now referring to the FIGS. 1-3, an engine hydraulic parallel series rear wheel drive hybrid vehicle of the present invention comprises a conventional vehicle power transmission system and an auxiliary hydraulic power transmission system. That is, the vehicle includes a brake pedal 2, an accelerator pedal 3, a rear wheel 21, a power transmission system comprising an engine 1, a gear-box 4 and a dual power driving rear axle 5, an electronic control unit 7, and a hydraulic auxiliary power transmission system. The hydraulic auxiliary power transmission system includes a first subsystem which is a brake energy regeneration auxiliary system and a second subsystem which is an idling energy control system. The engine 1 is connected to the gear-box 4. The gear-box 4 is connected to the dual power driving rear axle 5 by a universal coupling 6. Left and right wheels of a rear wheel 21 are connected with left and right half shafts of the dual power driving rear axle 5, respectively. The brake pedal 2 and accelerator pedal 3 are connected with the first subsystem and the second subsystem by an electronic control unit ECU 7. The electronic control unit ECU 7 functions to realize harmonious control between power transmission system and hydraulic auxiliary transmission system. Electronic control unit ECU 7 receives electric signals given by the brake pedal 2 and the accelerator pedal 3; meanwhile it also receives electric signals from the engine 1, the gear-box 4, the hydraulic accumulator, etc. After control strategic calculations, the electronic control unit ECU 7 outputs an instruction signal for the auxiliary hydraulic power transmission system. The structure of the electronic control unit ECU 7 is illustrated in FIG. 6.

The driving rear axle 5 is a dual power rear driving bridge for a parallel hybrid vehicle, such as the driving bridge described in Utility Model patent No. 200420000463.x of the present applicant. The engine 1 may be any type of engines, such as a diesel engine, a gasoline engine, etc.

The said first subsystem comprises a first hydraulic pump/motor 8, a first hydraulic integrated block 9, a first clutch 10, a gasoline strainer 16, a high pressure accumulator 11, a low pressure accumulator 12 and an auxiliary tank 13, wherein the numbers of the high pressure accumulator 11 and the low pressure accumulator 12 are respectively at least one. A power output shaft of the first hydraulic pump/motor 8 is mechanically connected with the dual power rear bridge 5 through a first clutch 10. The first hydraulic pump/motor 8 is a variable piston pump/motor, for which an electric input signal of the variable mechanism is provided by the electronic control unit ECU 7. An oil drain port 15 of the first hydraulic pump/motor 8 is connected to the auxiliary tank 13. An inlet and an outlet of the first hydraulic pump/motor 8 are connected to an inlet and an outlet of the first hydraulic integrated block 9 through two hydraulic tubes. An outlet of an internal oil protection check valve 27 is connected between an inlet of the first hydraulic pump/motor 8 and an outlet of the first hydraulic integrated block 9. An inlet of an internal oil protection check valve 27 is connected to an outlet of the auxiliary tank 13. The electronic control unit ECU 7 outputs an electric signal to control the operations of each hydraulic valve on the first hydraulic integrated block 9 according to gas-saving control strategy of whole vehicle. A gasoline strainer 16 is connected at outside of the first hydraulic integrated block 9. The first hydraulic integrated block 9 has an outlet leading to the high pressure accumulator 11, and the said outlet is connected with the high pressure accumulator 11 through a hydraulic tube. The first hydraulic integrated block 9 also has an outlet leading to the low pressure accumulator 12, and the said outlet is connected with the low pressure accumulator 12 through a hydraulic tube.

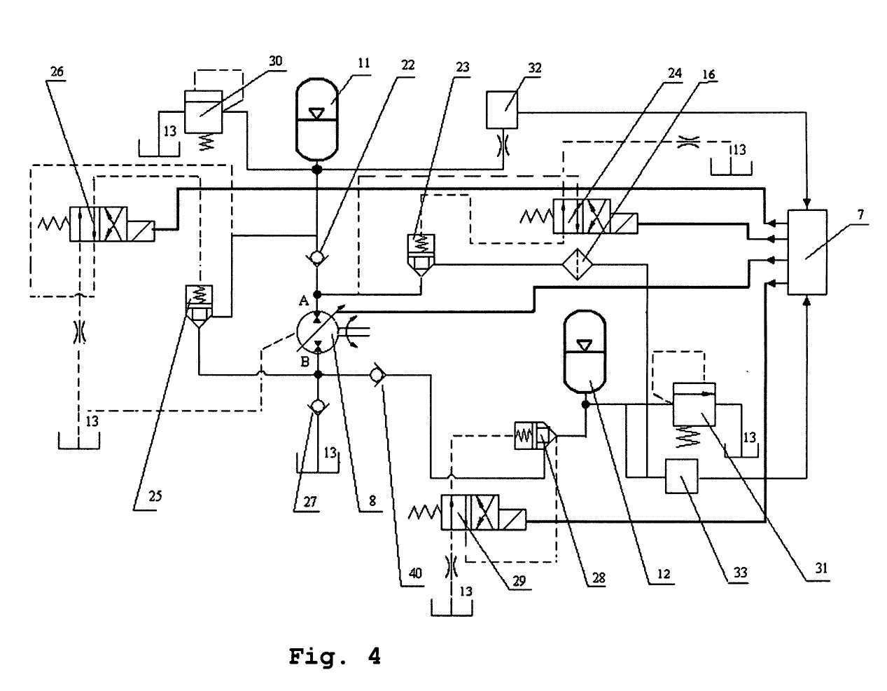

Referring to the FIG. 4, the first hydraulic integrated block 9 includes a control motor two position four way switching valve 24, a first control high pressure accumulator two position four way switching valve 26, a control low pressure accumulator two position four way switching valve 29, a first high pressure accumulator pressure maintaining check valve 22, an oil feed passage check valve 40, an internal oil protection check valve 27, a high pressure accumulator safety overflow valve 30, a low pressure accumulator safety overflow valve 31, a high pressure sensor 32 and a low pressure sensor 33. Each of two position four way switching valves has a cartridge valve, wherein all devices except check valves are controlled by the electric control unit ECU 7, as shown in the FIG. 6.

A port B of the first hydraulic pump/motor 8 is connected to the auxiliary tank 13 through the internal oil protection check valve 27. A port B of the first hydraulic pump/motor 8 is connected to the cartridge valve 28 of the control low pressure accumulator two position four way switching valve 29 through an oil feed passage check valve 40. The cartridge valve 28 of the control low pressure accumulator two position four way switching valve 29 is connected to the low pressure accumulator 12 via a hydraulic tube, and meanwhile the control low pressure accumulator two position four way switching valve 29 is connected to the auxiliary tank 13. An inlet of the low pressure accumulator 12 is connected to the safety overflow valve 31. The low pressure accumulator safety overflow valve 31 is connected to the auxiliary tank 13 via an oil tube. The port A of the first hydraulic pump/motor 8 is connected with the high pressure accumulator 11 through the first high pressure accumulator pressure maintaining check valve 22. The gasoline strainer 16 is connected via the cartridge valve 23 of the control motor two position four way switching valve 24 between the port A of the first hydraulic pump/motor 8 and the first high pressure accumulator pressure maintaining check valve 22. The low pressure accumulator 12 is connected with the gasoline strainer 16 via a hydraulic tube. The first high pressure accumulator pressure maintaining check valve 22 is connected with the high pressure accumulator 11 via an oil pressure conduit. The high pressure accumulator safety overflow valve 30 and the cartridge valve 25 of the first control high pressure accumulator two position four way switching valve 26 are connected via an oil pressure conduit between the first high pressure accumulator pressure maintaining check valve 22 and the high pressure accumulator 11. An outlet of a high pressure accumulator safety overflow valve 30 is connected to the auxiliary tank 13. Control terminals of the switching valves 24, 26 and 29 and a control terminal of the first hydraulic pump/motor 8 are connected with an I/O control terminal of the electronic control unit ECU 7 via bus. The voltage output terminals of the high pressure sensor 32 and the low pressure sensor 33 are connected via bus through an A/D sampling port of ECU.

A second subsystem comprises a second hydraulic pump/motor 17, a second hydraulic integrated block 18, a second clutch 19, a power take-off apparatus; the high pressure accumulator 11, the low pressure accumulator 12 and the auxiliary tank 13. In fact, two subsystems all use the same high pressure accumulator 11, low pressure accumulator 12 and auxiliary tank 13. The second hydraulic pump/motor 17 is a variable piston pump/motor, for which an electric input signal of the variable mechanism is provided by the electronic control unit ECU 7. A power output shaft of the second hydraulic pump/motor 17 is connected with a power take-off apparatus of the gear-box 4 through the second clutch 19. The power take-off apparatus is connected with the gear-box 4 or the engine 1. An oil drain port 15 of the second hydraulic pump/motor 17 is connected to the auxiliary tank 13. An inlet and an outlet of the second hydraulic pump/motor 17 are connected to an inlet and an outlet of the second hydraulic integrated block 18 through two hydraulic tubes. The electronic control unit ECU 7 outputs an electric signal to control the operations of each hydraulic valve on the second hydraulic integrated block 18 according to gas-saving control strategy of whole vehicle. The second hydraulic integrated block 18 has an outlet leading to the high pressure accumulator 11, and the said outlet is connected with the high pressure accumulator 11 through a hydraulic tube. The second hydraulic integrated block 18 also has an outlet leading to the low pressure accumulator 12, and the said outlet is connected with the low pressure accumulator 12 through a hydraulic tube.

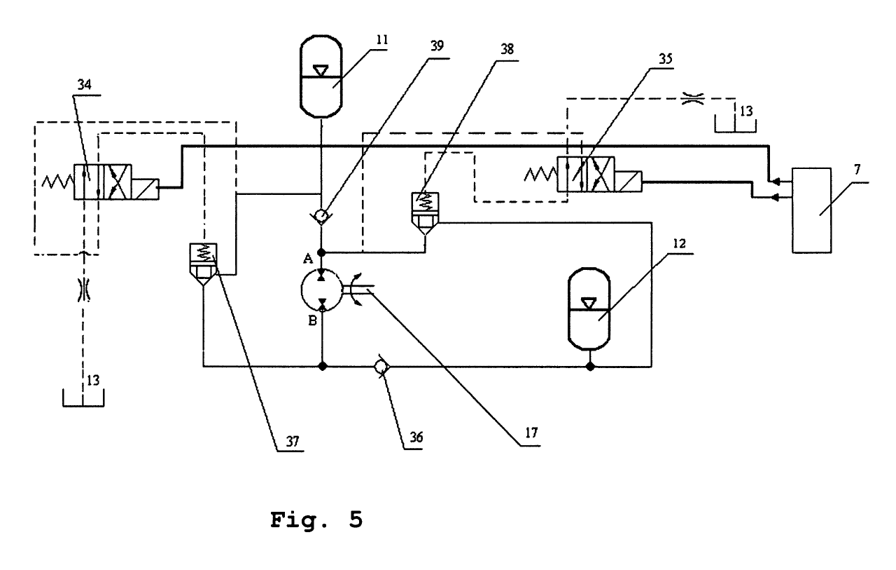

Referring to the FIG. 5, the second hydraulic integrated block 18 includes a control motor oil conduit distribution two position four way switching valve 34, a second control high pressure accumulator two position four way switching valve 35, a second high pressure accumulator pressure maintaining check valve 39 and an oil feed passage check valve 36. Each of the two position four way switching valves has a cartridge valve, wherein all devices except check valves are controlled by the electric control unit ECU 7 (referring to the FIG. 6). The port B of the second hydraulic pump/motor 17 is connected to an inlet of the low pressure accumulator 12 through the oil feed passage check valve 36. The cartridge valve 37 of the control motor oil conduit distribution two position four way switching valve 34 is connected between the high pressure accumulator 11 and the low pressure accumulator 12. An outlet of the control motor oil conduit distribution two position four way switching valve 34 is connected to the auxiliary tank 13. The cartridge valve 38 of the second control high pressure accumulator two position four way switching valve 35 is connected to the port A of the second hydraulic pump/motor 17. The control terminals of the switching valves 34 and 35 are connected with an I/O control terminal of the ECU 7 via bus. The second high pressure accumulator pressure maintaining check valve 39 is connected between the cartridge valve 37 and the cartridge valve 38.

Referring to the FIG. 1, in the first embodiment, a power take-off apparatus is a power take-off 20. A power take-off gear is mounted at the end of a power output shaft of the gear-box 4, and a power take-off mechanical interface is disposed thereon. The interface is positioned at the end of a gear-box 4 adjacent to the engine 1. The power take-off 20 is mounted on the gear-box 4 through the interface. A power output shaft is mounted inside the power take-off 20. A gear and a second clutch are mounted on a power output shaft. The gear is engaged with a power take-off gear of a power input end of the gear-box 4, so that the power of engine is output and transferred.

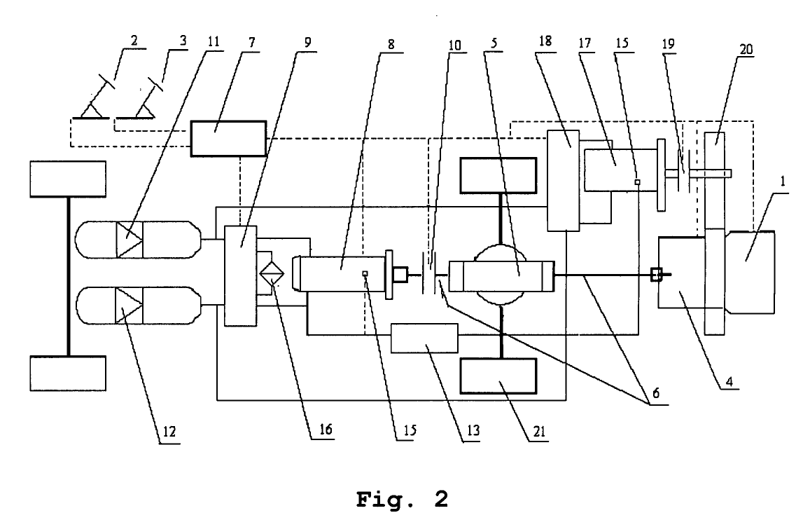

Referring to the FIG. 2, in the second embodiment, the power take-off apparatus is still a power take-off 20. The power take-off 20 is mounted at the end of the power output shaft of the engine 1. The gear-box 4 is connected to the other end of the power take-off 20. The gear and a second clutch 19 are mounted on the power output shaft of the power take-off 20. The gear is engaged with a power take-off gear of a power input end of the gear-box 4, so that the power of the engine is output and transferred.

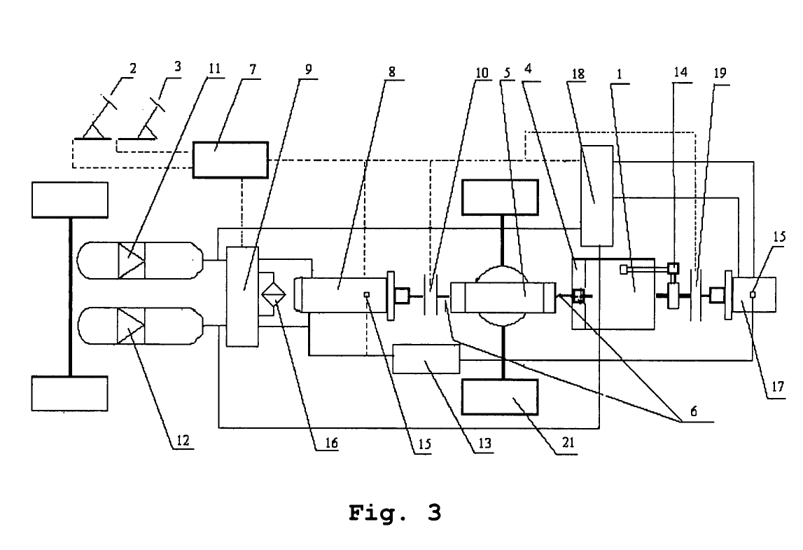

Referring to the FIG. 3, in the third embodiment, the power take-off apparatus is an engine power output mechanism 14, which includes an engine crank output shaft, a strap wheel, a driving strap and a bracket. A strap wheel is mounted at an end of an engine crank output shaft which is connected with another strap wheel through a strap. Another strap wheel is mounted at an end of a bracket, while the second hydraulic pump/motor 17 is mounted at the other end of the bracket. The second clutch 19 is mounted in the middle of the bracket. When the clutch is disengaged, the strap wheel at an end of the engine crank output shaft drives the strap wheel on the bracket to spin. Only when the clutch is engaged, the engine drives the hydraulic pump/motor rotating, so that the power of the engine is output and transferred.

### THE BASIC PRINCIPLE OF THE PRESENT INVENTION IS AS FOLLOWS

The operation process of the present invention is divided into four operation states, recovering hydraulic braking energy, releasing the recovered hydraulic energy, utilizing idling energy, and shutting down of engine when idling.

Four operation states are defined as follows:
1. Recovering of hydraulic brake energy is defined as: the energy generated when the vehicle is braking is recovered into a mechanical hydraulic accumulator through a hydraulic pump/motor, so that the brake energy which is to be wasted could be recovered and reused at the same time the vehicle is braking.
2. Releasing of hydraulic recovered energy is defined as: when the vehicle is starting and accelerating, a brake energy stored in the mechanical hydraulic accumulator is released through a hydraulic pump/motor. A hydraulic pump/motor drives the wheels to rotate, so that the gasoline is saved.
3. Utilizing of idling energy is defined as: in the state that a vehicle stops and an engine idles, the engine continues to provide a predetermined amount of energy. By using a hydraulic pump/motor, the energy that is provided by an engine in the state of idling is stored into a mechanical hydraulic accumulator, so as to help the vehicle start.
4. Idling and shutting down of engine is defined as: when the vehicle stops for a longer time, an engine is shut down automatically. When an engine is started again, an engine is started automatically by using a hydraulic pump/motor and a mechanical hydraulic accumulator.

I. Operation process of recovering of hydraulic brake energy and releasing of hydraulic recovered energy

A brake energy regeneration auxiliary power system and an idling energy control system can both complete two operation processes of recovering of brake energy and releasing of recovered energy.

(I) two operation processes completed by a brake energy regeneration auxiliary power system

When braking, a driver steps on a brake pedal. A displacement-electricity converter mounted on a brake pedal outputs and sends an electric signal to the electronic control unit ECU 7. After control strategic operation, the ECU 7 sequentially provides electric instructions to the first clutch 10, the first hydraulic integrated block 9 and the first hydraulic pump/motor 8. The first clutch 10 is firstly engaged, meanwhile the first hydraulic pump/motor 8 is driven to rotate by a wheel through the dual power driving rear axle 5. The hydraulic direction cartridge valve 23 on the first hydraulic integrated block 9 is then shut; meanwhile the exhaust of the first hydraulic pump/motor 8 is changed, so that the first hydraulic pump/motor 8 works in the state of a hydraulic pump. The first hydraulic pump/motor 8 sucks oil in the low pressure accumulator 12, and pumps it into the high pressure accumulator 11 in order to generate hydraulic pressure in the high pressure accumulator 11. The pressure enables the first hydraulic pump/motor 8 to form a moment for stopping the vehicle, so that the vehicle is braked. In the process of braking, the braking energy is continuously generated and stored into the high pressure accumulator 11. When the process of recovering of brake energy ends, the ECU 7 sends out an instruction to open the hydraulic direction cartridge valve 23 on the first hydraulic integrated block 9. The brake energy in the high pressure accumulator 11 is automatically closed by the first high pressure accumulator pressure maintaining check valve 22 on the first hydraulic integrated block 9.

The recovered energy is typically released when the vehicle starts and accelerates. A driver steps on the accelerator pedal 3. A displacement-electricity converter mounted on the accelerator pedal 3 outputs and sends an electric signal to the electronic control unit ECU 7. After control strategic operation, the ECU 7 sequentially provides electric instructions to the first clutch 10, the first hydraulic integrated block 9 and the first hydraulic pump/motor 8. The first clutch 10 is firstly engaged, and then the hydraulic direction cartridge valve 23 on the first hydraulic integrated block 9 is opened, meanwhile the exhaust of the first hydraulic pump/motor 8 is changed. At this point, the first hydraulic pump/motor 8 drives wheels to rotate through the dual power driving rear axle 5, so that the first hydraulic pump/motor 8 works in the state of a hydraulic motor. High pressure oil in the high pressure accumulator 11 enters the first hydraulic pump/motor 8, and then flows into the low pressure accumulator 12, so that the first hydraulic pump/motor 8 forms a moment for driving the vehicle running, such that the vehicle is started and accelerated. In the process of starting and accelerating, the stored brake energy is continuously released from the high pressure accumulator 11 into the first hydraulic pump/motor 8. When the process of recovering of energy ends, the ECU 7 sends out an instruction to shut the hydraulic direction cartridge valve 23 on the first hydraulic integrated block 9. The remaining brake energy in the high pressure accumulator 11 is automatically closed by the first high pressure accumulator pressure maintaining check valve 22 on the first hydraulic integrated block 9.

(II) two operation processes completed by a idling energy control system

When braking, a driver steps on the brake pedal. A displacement-electricity converter mounted on the brake pedal outputs and sends an electric signal to the electronic control unit ECU 7. After control strategic operation, the ECU 7 sequentially provides electric instructions to the second clutch 19, the second hydraulic integrated block 18 and the second hydraulic pump/motor 17. The second clutch 19 is firstly engaged, at this point, the gear-box is not neutral, the second hydraulic pump/motor 17 is driven to rotate by a wheel through the power take-off 20 mounted on the gear-box 4(or the engine 1) (in another embodiment, the wheel drives the engine 1 to rotate through the gear-box 4, a strap at an end of a crank output shaft of the engine drives the strap on the bracket to rotate. Due to the engagement of the second clutch 19, the second hydraulic pump/motor 17 is also driven to rotate by a wheel). The hydraulic direction cartridge valve 38 on the second hydraulic integrated block 18 is then shut, so that the second hydraulic pump/motor 17 works in the state of a hydraulic pump. The second hydraulic pump/motor 17 sucks oil in the low pressure accumulator 12, and pumps it into the high pressure accumulator 11 in order to generate hydraulic pressure in the high pressure accumulator 11. The pressure enables the second hydraulic pump/motor 17 to form a moment for stopping the vehicle running, so that the vehicle is braked. When the process of recovering of brake energy ends, the ECU 7 sends out an instruction to open the hydraulic direction cartridge valve on the second hydraulic integrated block 18. The brake energy in the high pressure accumulator 11 is automatically closed by the second high pressure accumulator pressure maintaining check valve 39 on the second hydraulic integrated block 18.

When the recovered energy is released, a driver steps on the accelerator pedal 3. The displacement-electricity converter mounted on the accelerator pedal 3 outputs and sends an electric signal to the electronic control unit ECU 7. After control strategic operation, the ECU 7 sequentially provides electric instructions to the second clutch 19, the second hydraulic integrated block 18 and the second hydraulic pump/motor 17. The second clutch 19 is firstly engaged, and then the hydraulic direction cartridge valve 37 on the second hydraulic integrated block 18 is opened. At this point, the second hydraulic pump/motor 17 drives wheels to rotate through the power take-off 20 mounted on the gear-box 4(or the engine 1)(in another embodiment, the second hydraulic pump/motor 17 provides strengthening force to the engine 1 through the strap wheel mounted on the bracket), so that the second hydraulic pump/motor 17 works in the state of a hydraulic motor. High pressure oil in the high pressure accumulator 11 enters the second hydraulic pump/motor 17, and then flows into the low pressure accumulator 12, so that the second hydraulic pump/motor 17 forms a moment for driving the vehicle running, such that the vehicle is started and accelerated. In the process of starting and accelerating, the recovered brake energy is continuously released from the high pressure accumulator 11 into the second hydraulic pump/motor 17. When the process of recovering of energy ends, the ECU 7 sends out an instruction to shut the hydraulic direction cartridge valve 37 on the second hydraulic integrated block 18. The remaining brake energy in the high pressure accumulator 11 is automatically closed by the second high pressure accumulator pressure maintaining check valve 39 on the second hydraulic integrated block 18.

II. Operation process of utilizing of idling energy

A second subsystem, i.e. idling energy control system completes the operation process of utilizing of idling energy. When the vehicle stops, the gear-box 4 is neutral, and the engine 1 is in the state of idling. If the high pressure accumulator 11 can continue to store brake energy, the electronic control unit ECU 7 firstly detects that the speed of the vehicle is zero, the gear-box 4 is neutral, and detects the pressure of the high pressure accumulator 11, then makes judgment through the control strategy, and sequentially provides electric instructions to the second clutch 19, the second hydraulic integrated block 18 and the second hydraulic pump/motor 17. The second clutch 19 is firstly engaged, and the second hydraulic pump/motor 17 is driven to rotate by the engine 1 through the power take-off 20 mounted on the gear-box 4(or an engine 1) (in another embodiment, the second hydraulic pump/motor 17 is driven to rotate by the engine 1 through the strap mounted on the bracket). The hydraulic direction cartridge valve 38 on the second hydraulic integrated block 18 is then shut, so that the second hydraulic pump/motor 17 works in the state of a hydraulic pump. The second hydraulic pump/motor 17 sucks oil in the low pressure accumulator 12, and pumps it into the high pressure accumulator 11 in order to generate hydraulic pressure in the high pressure accumulator 11. When the pressure in the high pressure accumulator 11 reaches a maximal predetermined pressure, the electronic control unit ECU 7 sends out instructions to firstly control the hydraulic direction cartridge valve 38 on the second hydraulic integrated block 18 to commutate so that the hydraulic system is unloaded. Then the second clutch 19 is disengaged, the second hydraulic pump/motor 17 stops rotating, and the energy in the high pressure accumulator 11 is closed by the second high pressure accumulator pressure maintaining check valve 39 on the second hydraulic integrated block 18. In this process, the engine 1 does not work when idling, and a portion of energy wasted is reused, so that the high pressure accumulator 11 maintains a maximal stored energy. Thus, the energy stored in the high pressure accumulator 11 is used when the vehicle starts and accelerates, whereby the gasoline is saved.

III. Operation process of idling and shutting down of engine

A idling energy control system completes the operation process of idling and shutting down of the engine 1. When the vehicle stops running, the gear-box 4 is neutral, and the engine 1 is in the state of idling. The electronic control unit ECU 7 firstly completes the operation process of utilizing of idling energy through control strategy. The electronic control unit ECU 7 sends out an instruction to automatically shut down the engine 1 when it detects that the pressure in the high pressure accumulator 11 has reached a maximal predetermined pressure. When a driver needs to restart the vehicle, he firstly steps on the accelerator pedal 3 slightly, then the electronic control unit ECU 7 detects the electric signal of the accelerator pedal 3. After judgment is made through control strategy, the ECU 7 sequentially provides electric instructions to the second clutch 19, the second hydraulic integrated block 18 and the second hydraulic pump/motor 17. The second clutch 19 is firstly engaged, the hydraulic direction cartridge valve 37 on the second hydraulic integrated block 18 is then shut. The liquid in the high pressure accumulator 11 flows into the second hydraulic pump/motor 17 through the cartridge valve 37, so that the second hydraulic pump/motor 17 works in the state of a hydraulic motor. The second hydraulic pump/motor 17 drives the engine 1 to rotate through the power take-off 20 mounted on the gear-box 4(or the engine 1) (in another embodiment, the second hydraulic pump/motor 17 drives the engine 1 to rotate through the strap wheel mounted on the bracket). When a driving power of the second hydraulic pump/motor 17 reaches a starting power of the engine 1, the engine 1 is started. When the electronic control unit ECU 7 detects that the rotating speed of the engine 1 reaches a rotating speed of idling, it sends out instructions to firstly control the hydraulic direction cartridge valve 38 on the second hydraulic integrated block 18 to commutate so that the hydraulic system is unloaded. Then the second clutch 19 is disengaged, the second hydraulic pump/motor 17 stops rotating, and the energy in the high pressure accumulator 11 is closed by the second high pressure accumulator pressure maintaining check valve 39 on the second hydraulic integrated block 18. The operation process of using the second hydraulic pump/motor 17 to start the engine 1 is completed.

IV. Working principle of hydraulic system

1. Working principle of the first subsystem: referring to the FIG. 4, the overflow valve 9 of the brake energy regeneration auxiliary hydraulic system is a safety valve of the high pressure accumulator 11 and functions to protect the high pressure accumulator 11. The overflow valve 10 of the hydraulic system is the safety valve of the low pressure accumulator 12 and functions to protect the low pressure accumulator 12. An auxiliary hydraulic tank provides supplementary oil to the hydraulic system in case of leakage and functions to cool down the hydraulic system. The internal oil protection check valve 27 ensures to suck necessary hydraulic oil from the auxiliary tank 13 when hydraulic system internal oil is insufficient. The second high pressure accumulator pressure maintaining check valve 39 functions to cut off an oil conduit leading to the low pressure accumulator when the second hydraulic pump/motor 17 is in the state of a motor. The second high pressure accumulator pressure maintaining check valve 39 functions to maintain the pressure for the high pressure accumulator 11. The pressure sensor 14 functions to detect the pressure of the high pressure accumulator 11. The pressure sensor 15 functions to detect the pressure of the low pressure accumulator 12. When the hydraulic system is in an initial state, the first hydraulic pump/motor 8 stops rotating, the two position four way switching valve 24 is turned off and is in left position, and at this point, the cartridge valve 23 is in the state of turning on. The two position four way switching valve 26 is turned off and is in left position, at this point, the cartridge valve 25 is in the state of turning off. The two position four way switching valve 29 is turned off and is in left position, at this point, the cartridge valve 28 is in the state of turning on.

When the hydraulic system is recovering brake energy of a vehicle, the first clutch 10 is engaged, and wheels drive the first hydraulic pump/motor 8 to rotate through the dual power driving rear axle 5. The electronic control unit ECU 7 sends out an instruction to control a two position four way switching valve 24 to be turned on. The two position four way switching valve 24 is turned on in left position, and at this point, the cartridge valve 23 is in the state of turning off. The two position four way switching valve 26 is turned off, in left position, and at this point, the cartridge valve 25 is in the state of turning off. The two position four way switching valve 29 is turned off, in left position, and at this point, the cartridge valve 28 is in the state of turning on. The first hydraulic pump/motor 8 sucks the hydraulic oil from the low pressure accumulator, and the hydraulic oil flows into the high pressure accumulator 11 through the first high pressure accumulator pressure maintaining check valve 22.

When the process of recovering brake energy of the vehicle ends, the electronic control unit ECU 7 sends out an instruction to control the two position four way switching valve 24 to be turned off. The two position four way switching valve 24 is turned on in left position, and at this point, the cartridge valve 23 is in the state of turning on. The first hydraulic pump/motor 8 is unloaded in middle position. After this, the electronic control unit ECU 7 sends out an instruction to make the first clutch 10 disengaged. The process of recovering brake energy of the vehicle is completed.

When the hydraulic system is releasing brake energy of a vehicle, the electronic control unit ECU 7 sends out an instruction to control the first clutch 10 to be engaged and the two position four way switching valve 26 to be turned on. The two position four way switching valve 26 is turned on in right position, and at this point, the cartridge valve 25 is in the state of turning on. The two position four way switching valve 26 is turned off in left position, and at this point, the cartridge valve 23 is in the state of turning on. The two position four way switching valve 29 is turned off and is in left position, and at this point, the cartridge valve 28 is in the state of turning on. The hydraulic oil of the high pressure accumulator 11 is applied to an inlet of the first hydraulic pump/motor 8 through the cartridge valve 25. The hydraulic oil at an outlet of the first hydraulic pump/motor 8 flows into the gasoline strainer 16 through the cartridge valve 23, and then flows into the low pressure accumulator 12. When the process of releasing brake energy of the vehicle ends, the electronic control unit ECU 7 sends out the instruction to control the two position four way switching valve 26 to be turned off. The two position four way switching valve 26 is turned off in left position, and at this point, the cartridge valve 25 is in the state of turning off. The hydraulic oil in the high pressure accumulator 11 is closed by the first high pressure accumulator pressure maintaining check valve 22 and the cartridge valve 25. The hydraulic pump/motor is unloaded in middle position. After this, the electronic control unit ECU 7 sends out the instruction to make the first clutch 10 disengaged. The process of releasing brake energy of the vehicle is completed.

In the case that the hydraulic system is needed to be supplemented with hydraulic oil, when the hydraulic system is short of hydraulic oil due to inner and outer leakage of the hydraulic component, it is needed to supplement hydraulic oil into the inner of the hydraulic system through 13. The electronic control unit ECU 7 sends out an instruction to control the first clutch 10 to be engaged. Wheels drive the first hydraulic pump/motor 8 to rotate through the dual power driving rear axle 5 and control the two position four way switching valve 29 to be turned on. The two position four way switching valve 29 is turned on in right position, and at this point, the cartridge valve 28 is in the state of turning off. The two position four way switching valve 26 is turned off and is in left position, and at this point, the cartridge valve 25 is in the state of turning off. The two position four way switching valve 24 is turned off and is in left position, and at this point, the cartridge valve 23 is in the state of turning on. The first hydraulic pump/motor 8 sucks the hydraulic oil from the auxiliary tank 13, and the hydraulic oil flows into the inlet of the first hydraulic pump/motor 8 through the internal oil protection check valve 27, and then flows into the cartridge valve 23, the gasoline strainer 16 and the low pressure accumulator through the outlet of the first hydraulic pump/motor 8, so that the hydraulic oil is supplemented. When the process of supplementing oil ends, the electronic control unit ECU 7 sends out an instruction to control the two position four way switching valve 29 to be turned off. The two position four way switching valve 29 is turned on in left position, and at this point, the cartridge valve 28 is in the state of turning on. The hydraulic system is unloaded in middle position, and the first clutch 10 is disengaged. The process of supplementing oil is completed.

2. Operation principle of the second subsystem: referring to FIG. 5, the idling power hydraulic system must be used together with the hydraulic system of the hydraulic auxiliary power first subsystem, and is in parallel with the hydraulic auxiliary power subsystem 1. The idling power hydraulic system uses the overflow valve 9 and the overflow valve 10 in the hydraulic auxiliary power subsystem 1 for safety protection of the high pressure accumulator 11 and the low pressure accumulator 12. The pressure sensor 14 and 15 of the hydraulic auxiliary power subsystem 1 are used for detecting the pressure of high/low pressure accumulators. When the oil feed passage check valve 36 ensures the second hydraulic pump/motor 17 to be in the state of motor, the passage from the high pressure accumulator 11 to the low pressure accumulator 12 at the inlet of the second hydraulic pump/motor 17 is cut off. When the second hydraulic pump/motor 17 is in the state of pump, the low pressure accumulator 12 provides hydraulic oil to the inlet of pump state of the second hydraulic pump/motor 17. The second high pressure accumulator pressure maintaining check valve 39 functions to maintain the pressure of the high pressure accumulator 11.

When the hydraulic system is in the initial state, the second clutch 9 is disengaged, the first hydraulic pump/motor 8 stops rotating, the two position four way switching valve 35 is turned off and is in left position, and at this point, the cartridge valve 38 is in the state of turning on. The inlet and the outlet of the second hydraulic pump/motor 17 are connected with the low power accumulator, and the system is in the unloading state. The two position four way switching valve 34 is turned off and is in left position, and at this point, the cartridge valve 37 is in the state of turning off.

When the hydraulic system stores energy into the high pressure accumulator 11 by using the idling power, the second clutch 19 is engaged, the engine 1 drives the second hydraulic pump/motor 17 to rotate through the power take-off apparatus of the gear-box 4 or the engine l(also including the strap driven by the crank output shaft of the engine 1). The electronic control unit ECU 7 sends out an instruction to control the two position four way switching valve 35 to be turned on. The two position four way switching valve 35 is turned on in right position, and at this point, the cartridge valve 38 is in the state of turning on. The two position four way switching valve 34 is turned off and is in left position, and at this point, the cartridge valve 25 is in the state of turning off. The second hydraulic pump/motor 17 sucks hydraulic oil from the low pressure accumulator through 36, and hydraulic oil flows into the high pressure accumulator 11 through the second high pressure accumulator pressure maintaining check valve 39, so that the idling power is utilized. When the pressure sensor 14 of the hydraulic auxiliary power subsystem detects that the pressure of the high pressure accumulator 11 reaches a maximal operation pressure, the process of utilizing the idling power ends. The electronic control unit ECU 7 sends out an instruction to control the two position four way switching valve 35 to be turned off. The two position four way switching valve 35 is turned on in left position, and at this point, the cartridge valve 38 is in the state of turning on. The second hydraulic pump/motor 17 is unloaded in the middle position. After this, the electronic control unit ECU 7 sends out an instruction to make the first clutch 10 disengaged. The operation process of utilizing idling power is completed.

When the hydraulic system releases energy stored in the high pressure accumulator 11 and starts the engine 1 or provides the strengthening force to the engine 1, the electronic control unit ECU 7 sends out an instruction to control the second clutch 19 to be engaged and the two position four way switching valve 34 to be turned on. The two position four way switching valve 34 is turned on in right position, and at this point, the cartridge valve 37 is in the state of turning on. The two position four way switching valve 35 is turned off in left position, and at this point, the cartridge valve 38 is in the state of turning on. The hydraulic oil of the high pressure accumulator 11 is applied at an inlet of the second hydraulic pump/motor 17 through the cartridge valve 38, and the second hydraulic pump/motor 17 is operating in the state of the motor. The second hydraulic pump/motor 17 drives the engine 1 to rotate through the power take-off apparatus of the gear-box 4 or the engine 1. The hydraulic oil at the outlet of the second hydraulic pump/motor 17 flows into the low pressure accumulator 12 through the cartridge valve 38, so that the engine 1 is started and the strengthening force is provided to the engine 1. When the pressure sensor 14 of the hydraulic auxiliary power subsystem detects that the pressure of the high pressure accumulator 11 is released to minimal operation pressure, the operation process of starting the engine 1 and providing the strengthening force to the engine 1 should be ended. At this point, the electronic control unit ECU 7 sends out an instruction to control the two position four way switching valve 34 to be turned off. The two position four way switching valve 34 is turned off in left position, and at this point, the cartridge valve 37 is in the state of turning off. Hydraulic oil in the high pressure accumulator 11 is closed by the check valve 23 and the cartridge valve 37, and the second hydraulic pump/motor 17 is unloaded in middle position. After this, the electronic control unit ECU 7 sends out an instruction to make the second clutch 19 disengaged. The operation process of starting the engine 1 and providing the strengthening force to the engine 1 is completed.

### INDUSTRIAL APPLICABILITY

As described above, the engine hydraulic parallel series rear wheel drive hybrid vehicle of present invention can realize four operation states such as recovering state of hydraulic brake energy, releasing state of hydraulic stored energy, utilizing state of idling energy and idling and shutting down state of engine. The present invention not only can satisfy the need that the vehicle is running on speedway in modern city, but also can be applicable for a vehicle to run in a lower speed in the local streets, stop frequently, and reuse the remaining energy when idling. The present invention also has advantages of higher efficiency for kinetic energy conversion, lower noise, longer lifetime of engine, gas-saving, simpler structure, as well as lower cost. The present invention is applicable to the reconfiguration of existing vehicle and further applicable to industrial production, because the components used in present invention are all common universal components.

What is claimed is:

1. An engine hydraulic parallel series rear wheel drive hybrid vehicle comprising a brake pedal (2), a accelerator pedal (3), a rear wheel (21), and a power transmission system comprising a engine (1), a gear-box (4) and a dual power driving rear axle (5);
wherein the engine (1) is connected to the gear-box (4), the gear-box (4) is connected to the dual power driving rear axle (5) through a universal coupling (6), left and right wheels of the rear wheel (21) are connected with left and right half shafts of the dual power driving rear axle (5), respectively, the vehicle further comprising: a electronic control unit (7), and a hydraulic auxiliary power transmission system including a first subsystem and a second subsystem;
wherein the first subsystem is a brake energy regeneration auxiliary system and the second subsystem is an idling energy control system;
wherein the brake pedal(2) and the accelerator pedal (3) are connected with the first subsystem and the second subsystem through the electronic control unit (7), and wherein after receiving electric signals given by the brake pedal (2) and the accelerator pedal (3), the engine (1), and the gear-box (4), the electronic control unit (7) outputs an instruction signal for operation of the auxiliary hydraulic power transmission system.

2. An engine hydraulic parallel series rear wheel drive hybrid vehicle according to claim 1, wherein: the first subsystem comprises a first hydraulic pump/motor (8), a first hydraulic integrated block (9), a first clutch (10), a gasoline strainer (16), a high pressure accumulator (11), a low pressure accumulator (12) and a auxiliary tank (13), wherein the power output shaft of the first hydraulic pump/motor (8) is connected with the dual power rear bridge (5) through the first clutch (10), the oil drain port (15) of the first hydraulic pump/motor (8) is connected to the auxiliary tank (13), the first hydraulic pump/motor (8) is connected to the first hydraulic integrated block (9), the gasoline strainer (16) is connected at outside of the first hydraulic integrated block (9), the first hydraulic integrated block (9) has an outlet leading to the high pressure accumulator (11) and the low pressure accumulator (12).

3. An engine hydraulic parallel series rear wheel drive hybrid vehicle according to claim 2, wherein: the first hydraulic pump/motor (8) is a variable piston pump/motor, for which an electric input signal of the variable mechanism is provided by the electronic control unit (7).

4. An engine hydraulic parallel series rear wheel drive hybrid vehicle according to claim 2, wherein: the first hydraulic integrated block (9) includes a first high pressure accumulator pressure maintaining check valve (22), a high pressure sensor (32) connected with the high pressure accumulator (11), a low pressure sensor (33) connected with the low pressure accumulator (12), a oil feed passage check valve (40), and a control motor two position four way switching valve (24), a first control high pressure accumulator two position four way switching valve (26), a control low pressure accumulator two position four way switching valve (29), an internal oil protection check valve (27), a high pressure accumulator safety overflow valve (30) and a low pressure accumulator safety overflow valve (31) connected with the auxiliary tank (13), respectively, wherein each of two position four way switching valves has a cartridge valve, an oil feed passage check valve (40), a cartridge valve (28) of the control low pressure accumulator two position four way switching valve (29) and the low pressure accumulator (12) are sequentially connected between a port B of the first hydraulic pump/motor (8) and a low pressure accumulator safety overflow valve (31), the gasoline strainer (16) is connected via a cartridge valve (23) of the control motor two position four way switching valve (24) between the port A of the first hydraulic pump/motor (8) and the first high pressure accumulator pressure maintaining check valve (22), the low pressure accumulator (12) is connected with the gasoline strainer (16), the high pressure accumulator safety overflow valve (30) and a cartridge valve (25) of the first control high pressure accumulator two position four way switching valve (26) are connected between the first high pressure accumulator pressure maintaining check valve (22) and the high pressure accumulator (11), the control terminals of the two position four way switching valves (24), (26) and (29) and the control terminal of the first hydraulic pump/motor (8) are connected with an I/O output terminal of the electronic control unit (7), the high pressure sensor (32) and the low pressure sensor (33) are connected with the A/D input terminal of the electronic control unit (7).

5. An engine hydraulic parallel series rear wheel drive hybrid vehicle according to claim 2, wherein: the second subsystem comprises the second hydraulic pump/motor (17), a second hydraulic integrated block (18), a second clutch (19), a power take-off apparatus, and a high pressure accumulator (11), a low pressure accumulator (12) and an auxiliary tank (13) commonly used by the first subsystem; the second hydraulic pump/motor (17) is connected with the power take-off apparatus; the power take-off apparatus is connected with the gear-box (4) or the engine (1), the oil drain port (15) of the second hydraulic pump/motor (17) is connected to the auxiliary tank (13), the second hydraulic pump/motor (17) is connected with the second hydraulic integrated block (18), the second hydraulic integrated block (18) has oil ports leading to the high pressure accumulator (11) and the low pressure accumulator (12) respectively.

6. An engine hydraulic parallel series rear wheel drive hybrid vehicle according to claim 5, wherein: the second hydraulic pump/motor (17) is a variable piston pump/motor, for which a electric input signal of the variable mechanism is provided by the electronic control unit (7).

7. An engine hydraulic parallel series rear wheel drive hybrid vehicle according to claim 5, wherein: the power take-off apparatus is a power take-off (20), a power take-off gear and a power take-off mechanical interface engaged with a gear on a power output shaft of the power take-off (20) are mounted at the end of a power input shaft of the gear-box (4), the power take-off (20) is mounted on the gear-box (4) through the interface.

8. An engine hydraulic parallel series rear wheel drive hybrid vehicle according to claim 5, wherein: the power take-off apparatus is a power take-off (20), the power take-off (20) is mounted at the end of a power output shaft of the engine (1), the gear-box (4) is connected to the other end of the power take-off (20), a power take-off gear engaged with a gear on a power output shaft of the power take-off (20) is mounted at the end of a power input shaft of the gear-box (4).

9. An engine hydraulic parallel series rear wheel drive hybrid vehicle according to claim 5, wherein: the power take-off apparatus is a engine power output mechanism (14), which comprises an engine crank output shaft, a strap wheel, a driving strap and a bracket, the strap wheel is mounted at an end of an engine crank output shaft which is connected with another strap wheel mounted at an end of the bracket through a strap, the other end of the bracket is connected with the hydraulic pump, the second clutch (19) is mounted in the middle of the bracket.

10. An engine hydraulic parallel series rear wheel drive hybrid vehicle according to claim 5, wherein: the second hydraulic integrated block (18) comprises a second high pressure accumulator pressure maintaining check valve (39), a oil feed passage check valve (36), and a control motor oil conduit distribution two position four way switching valve (34) and a second control high pressure accumulator two position four way switching valve (35) that are respectively connected with the auxiliary tank (13), wherein, Each of two position four way switching valves has a cartridge valve, a port B of the second hydraulic pump/motor (17) is connected to the low pressure accumulator (12) through the oil feed passage check valve (36), a port A of the second hydraulic pump/motor (17) is connected to the high pressure accumulator through the second high pressure accumulator pressure maintaining check valve (39), a cartridge valve (37) of the control motor oil conduit distribution two position four way switching valve (34) is connected between the high pressure accumulator (11) and the oil feed passage check valve (36), the second high pressure accumulator pressure maintaining check valve (39) is connected between the cartridge valve (37) and a cartridge valve (38) of the second control high pressure accumulator two position four way switching valve (35), the cartridge valve (38) is connected with the port A of the second hydraulic pump/motor (17) and the low pressure accumulator (12), control terminals of the two position four way switching valves (34) and (35) are connected with an I/O output terminal of the electronic control unit (7).

11. An engine hydraulic parallel series rear wheel drive hybrid vehicle according to claims 4 or 10, wherein: when the first hydraulic pump/motor (8) or the second hydraulic pump/motor (17) is used in the state of a hydraulic pump, the port A is a high pressure oil-pushing port, the port B is a low pressure oil-sucking port; when the first hydraulic pump/motor (8) or the second hydraulic pump/motor (17) is used in the state of a motor, the port A is a low pressure oil-return port, the port B is a high pressure oil-entry port.

12. An engine hydraulic parallel series rear wheel drive hybrid vehicle according to any one of claims 1 to 10, wherein: the numbers of the high pressure accumulator (11) and the low pressure accumulator (12) are respectively at least one.

13. An engine hydraulic parallel series rear wheel drive hybrid vehicle according to any one of claims 1 to 10, wherein: the dual power driving rear axle (5) is a dual power driving rear axle for parallel hybrid vehicle.
